(19) United States
(12) Patent Application Publication
(10) Pub. No.: US 2002/0034962 A1
(43) Pub. Date: Mar. 21, 2002

(54) Subscriber wireless access system

(76) Inventor: Naoki Yokoyama, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 09/944,124

(22) Filed: Sep. 4, 2001

(30) Foreign Application Priority Data
Sep. 5, 2000 (JP) 2000-268794

(51) Int. Cl. H04B 7/00

(52) U.S. Cl. 455/519; 455/518; 455/418

(57) ABSTRACT

Subscriber station IDs added to subscriber station devices, and pieces of subscriber group number information representing the same group are added to the subscriber station devices to group the subscriber station devices. A base station apparatus holds a corresponding table between subscriber station IDs and subscriber group numbers and designates broadcast data received from a subscriber station device such that a subscriber station device belonging to the same group as that of a subscriber station device of a transmission source as a destination to forward the broadcast data to a wireless area. The table can be updated by an SNMP manager device connected through a communication network WAN.

### BACKGROUND OF THE INVENTION

1. Field of the Invention

The present invention relates to a subscriber wireless access system (to be referred to as an FWA or the like) in which a communication terminal device such as a personal computer or a LAN to which the communication terminal device is connected is accommodated in a subscriber station device wirelessly connected to a base station apparatus and, more specifically, a technique which prevent generation of unnecessary traffic caused by broadcast data.

2. Description of the Prior Art

In recent years, various communication terminal devices such as personal computers, mobile tools, and mobile telephone sets are familiarly used. A wireless LAN which connects the communication terminal devices to each other with a wireless system is developed and practically used.

A subscriber wireless access system in which a communication terminal device or a LAN to which a communication terminal device is connected is accommodated in a subscriber station device to wirelessly connect the subscriber station device to a base station apparatus is developed and practically used.

In such a subscriber wireless access system, a communication network on the base station apparatus side and the communication terminal device on the subscriber station device side can be connected to each other through wireless communication between the base station apparatus and the subscriber station device. The base station apparatus is functioned as a bridge, the communication terminal devices of a plurality of subscriber station devices which are accommodated in the same base station apparatus can also be connected to each other.

Therefore, when the subscriber wireless access system is used, by establishing a base station apparatus and a subscriber station device, a communication terminal device or a LAN thereof can be easily connected to a communication network without constructing communication lines.

When the subscriber wireless access system is used, a plurality of subscriber station devices accommodated in the same base station apparatus can also be grouped and set. The following advantages can be achieved. For example, a LAN of a certain subscriber is divided into several LANs, and the LANs are connected to each other by different subscriber station devices in the same group to secure a large communication band. In an establishment (subscriber) having several buildings, LANs established in the respective buildings are connected to each other by different subscriber station devices in the same group to integrate LANs as the entire establishment.

In the subscriber wireless access system, as in a general network, various broadcast data are communicated. However, when the subscriber station devices are grouped, since the subscriber station devices are connected to the same base station apparatus, broadcast data which is required in only a certain group is also transmitted to another group (including a case in which only one subscriber station device is used), and unnecessary broadcast data causes a needless increase in traffic. In addition, when establishments of different companies are accommodated in the same base station apparatus, the secrecy of the broadcast data cannot be secured between the groups.

### SUMMARY OF THE INVENTION

The present invention has been made in consideration of the above problems, and has as its object to provide a subscriber wireless access system and a subscriber wireless access method which control communication of broadcast data between subscriber station device groups to prevent an increase in unnecessary traffic and which can secure the secrecy of the broadcast data.

It is another object of the present invention to provide a subscriber wireless access system and a subscriber wireless access method which can easily the grouping process.

The still another objects of the present invention will be apparent in the following description.

According to the present invention, there is provided a subscriber wireless access system which has subscriber station devices wirelessly connected to base station apparatus, communication terminal devices being accommodated in the subscriber station devices, wherein pieces of information for discriminating the subscriber station devices from each other are added to the subscriber station devices, pieces of group discrimination information representing the same group are added to a plurality of subscriber station devices wirelessly connected to the same base station apparatus to group the subscriber station devices, the base station apparatus holds corresponding information between pieces of individual discrimination information of the subscriber station devices and the pieces of group discrimination information, and, when the base station apparatus receives broadcast data from a subscriber station device, the base station apparatus designates a subscriber station device belonging to the same group as that of a subscriber station device of a transmission source as a destination to wirelessly transmit the broadcast data to the subscriber station device.

Information according to a destination group of broadcast data is added to a subscriber station device as a tag (VLAN-Tag) set for an ethernet communication frame conforming to, e.g., IEEE802.1Q, so that a subscriber station device belonging to the same group is designated as a destination.

Therefore, when broadcast data such as an ARP (Address Resolution Protocol) or data used in only a certain establishment which is transmitted in only a certain group is transmitted, only a subscriber station device belonging to the same group as that of the subscriber station device serving as the transmission source performs a receiving process of the broadcast data and transmits the broadcast data to a communication terminal device (including a LAN) under the control of the subscriber station device.

In the subscriber wireless access system according to the present invention, the base station apparatus holds corresponding information between pieces of individual discrimination information of subscriber station devices and pieces of group discrimination information such that the corresponding information can be updated, and the group configuration of the subscriber station devices can be changed.

The subscriber wireless access system according to the present invention comprises a network management device (for example, an SNMP (Simple Network Monitor Protocol) manager device) connected to a base station apparatus through a communication network. The corresponding information between pieces of individual discrimination information of subscriber station devices held by the base station apparatus and pieces of group discrimination information can be updated by the network management device.

Therefore, the subscriber station device accommodated in a group can be easily changed. This change can be subjected to a remote control process and managed by the network management apparatus.

More specifically, according to the present invention, there is provided a subscriber wireless access system which has a base station apparatus connected to a communication network through a router and subscriber station devices wirelessly connected to the base station apparatus, communication terminal devices being accommodated in the subscriber station devices, wherein the router is connected to the base station apparatus by a plurality of logical channels and holds corresponding information between IP addresses of data communicated on the communication network and the logical channels, the base station apparatus holds corresponding information between the logical channels and pieces of information for discriminating the subscriber station devices from each other and corresponding information between pieces of group discrimination information of a plurality of subscriber station devices wirelessly connected to the base station apparatus and pieces of individual discrimination information of the subscriber station devices and sets destination information of data transmitted to a subscriber station device with reference to the pieces of corresponding information.

Therefore, communication between a communication network such as a WAN (Wide Area Network) and a subscriber station device can be performed by wireless communication through a base station apparatus, and broadcast data communication to the above subscriber station device group can be controlled.

According to the present invention, there is provided a method of transmitting broadcast data to only a predetermined subscriber station device group in a subscriber wireless access system, a base station apparatus designates a destination of the received broadcast data as a group with reference to group discrimination information representing that a plurality of subscriber station devices belong to the same group to wirelessly transmit the broadcast data to the subscriber station device, and the subscriber station device which wirelessly receives the broadcast data outputs the broadcast data to a communication terminal device controlled under the subscriber station device only when the subscriber station device belongs to the group the destination of which is designated.

According to the present invention, there is provided a subscriber wireless access method which changes a configuration of a group constituted by subscriber station devices wirelessly connected to the same base station apparatus in a subscriber wireless access system, wherein corresponding information between pieces of group discrimination information of the subscriber station devices held in the base station apparatus and pieces of individual discrimination information of the subscriber station devices is updated.

### BRIEF DESCRIPTION OF THE DRAWINGS

FIG. 1 is a diagram of a subscriber wireless access system according to an embodiment of the present invention;

FIG. 2 is a conceptual diagram for explaining an ethernet frame according to an example of the present invention; and

FIGS. 3A and 3B are conceptual diagrams for explaining wireless frames according to an example of the present invention.

### DESCRIPTION OF THE PREFERRED EMBODIMENTS

The present invention will be described below by using, as an example, a communication method achieved by an ethernet communication frame in which VLAN-Tag is set in conformity to IEEE802.1Q.

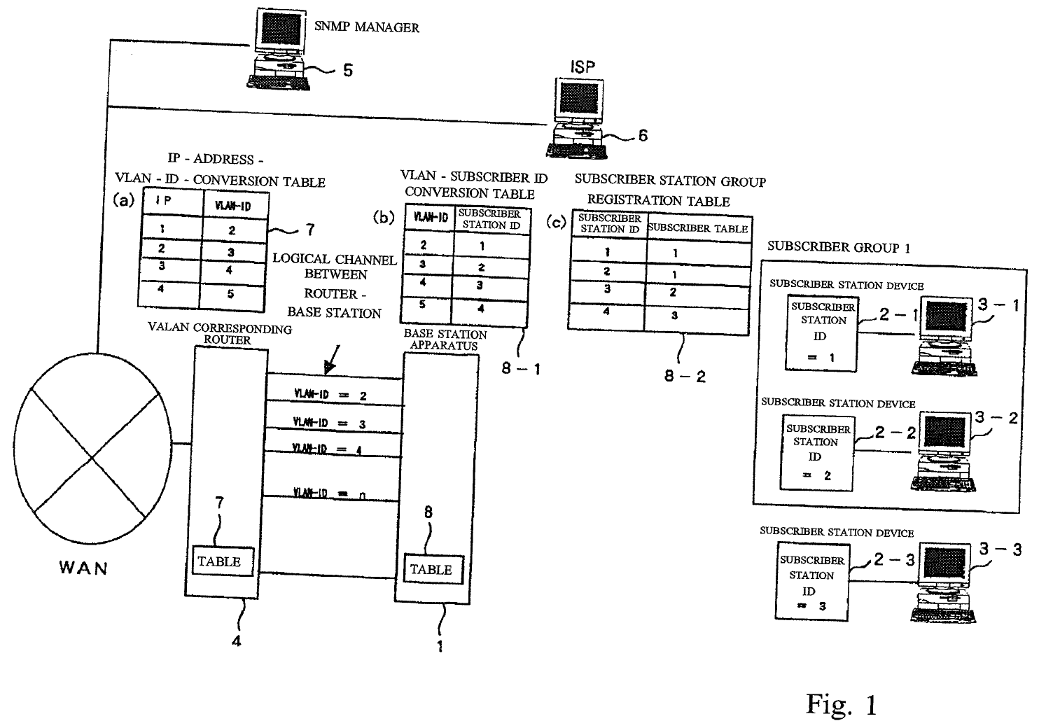

FIG. 1 shows the contents of the configuration of a subscriber wireless access system according to this embodiment and a correspondence table.

As shown in FIG. 1, a plurality of subscriber station devices (in this embodiment, three subscriber station devices 2-1, 2-2, and 2-3) wirelessly connected to a base station apparatus 1, and communication terminal devices 3-1, 3-2, and 3-3 are connected to the subscriber station devices 2-1, 2-2, and 2-3, respectively. Subscriber station IDs are added to the subscriber station devices to discriminate the subscriber station devices from each other. Subscriber station ID=1 is set for the subscriber station device 2-1, subscriber station ID=2 is set for the subscriber station device 2-2, and subscriber station ID=3 is set for the subscriber station device 2-3.

The base station apparatus 1 is connected to a wide area network WAN through a VLAN corresponding router 4. An SNMP manager device 5 for managing communication between the base station apparatus 1 and a subscriber station device, an ISP (ISDN service processing) device 6 for managing ISDN communication service, another VLAN corresponding router being outside the drawing, a base station apparatus, and the like are connected to the wide area network WAN.

A general router is interposed between these nodes, and route control of data communication between these nodes through the wide area network WAN is performed.

The data communication between the VLAN corresponding router 4 and the base station apparatus 1 is performed by a method in which an IP address used on the wide area network WAN is assigned to a logical channel number (VLAN-ID). The VLAN corresponding router 4 performs conversion control between an IP address of communication data and a logical channel.

In order to perform this conversion control, the VLAN corresponding router 4 has a conversion table 7 for corresponding to an IP address to a VLAN-ID. As indicated by (a) in FIG. 1, correspondence between IP addresses and VLAN-IDs is uniquely established such that IP address=1 corresponds to VLAN-ID=2, IP address=2 corresponds to VLAN-ID=3, . . . .

The base station apparatus 1 has an MIB table 8 which can be subjected to an updating process by the SNMP manager device 5 through the wide area network WAN. This MIB table 8 includes, as indicated by (b) in FIG. 1, a conversion table 8-1 for establishing correspondence between the VLAN-IDs and the subscriber station IDs and, as indicated by (c) in FIG. 1, a registration table 8-2 for establishing correspondence between the respective subscriber station IDs and group IDs to which the subscriber station devices belong.

The conversion table 8-1 uniquely establishes correspondence between VLAN-IDs and subscriber station IDs such that VLAN-ID=2 corresponds to subscriber station ID=1, VLAN-ID=3 corresponds to subscriber station ID=2, . . . . Correspondence between the respective subscriber station devices 2-1, 2-2, 2-3, . . . and VLAN-IDs is uniquely established, and correspondence between the respective subscriber station devices 2-1, 2-2, 2-3, . . . and IP addresses is uniquely established on the basis of the conversion table 7.

In the illustrated example, the subscriber station device 2-1 of subscriber station ID=1 and the subscriber station device 2-2 of subscriber station ID=2 are set to the same group (subscriber group 1) connected to the same base station apparatus 1, and subscriber station devices of other subscriber station IDs connected to the same base station apparatus 1 are independently set to different groups (subscriber groups 2 and 3). In this manner, the registration table 8-2 uniquely establishes correspondence between the subscriber IDs and group IDs to which the subscriber IDs belong such that subscriber station ID=1 corresponds to subscriber group ID=1, subscriber station ID=2 corresponds to subscriber group ID=1, subscriber station ID=3 corresponds to subscriber group ID=2, . . . .

In a service contract of a subscriber wireless access system, the SNMP manager device 5 establishes the correspondence between the subscriber station ID of a new subscriber station device and a group ID as described above and registers the correspondence in the MIB table 8.

In this example, the SNMP manager device 5 performs updating management. However, for example, when a local system configuration is considered, the MIB table 8 is directly updated when the base station apparatus 1 is maintained and managed.

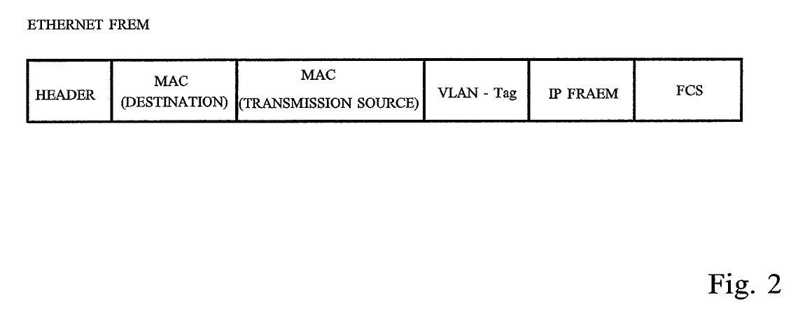

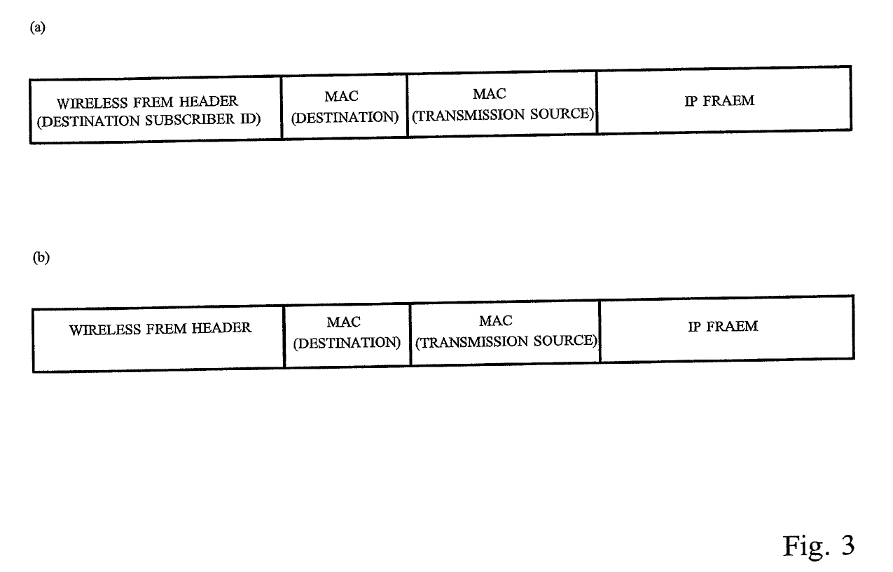

In the subscriber wireless access system with the above configuration, when the VLAN corresponding router 4 receives unicast data from the wide area network WAN, the VLAN corresponding router 4 converts the destination IP address of the received data into a VLAN-ID with reference to the conversion table 7, and transmits the received data to the base station apparatus 1 by the logical channel through an ethernet frame to which a VLAN-Tag is added as shown in FIG. 2. The subscriber station ID is decided from the VLAN-ID received by the base station apparatus 1 with reference to the conversion table 8-1, unicast data which is received such that the subscriber station ID is included in a wireless frame header as shown in FIG. 3A and the subscriber station device of the subscriber station ID is set as a destination is wirelessly transmitted.

In transmission of unicast data between the subscriber station devices 2-1, 2-2, 2-3, . . . under the control of the base station apparatus 1, the base station apparatus 1 functions as a bridge, and the unicast data is wirelessly repeated by a wireless frame in which a destination and a transmission source are designated by MAC addresses for specifying respective communication terminal devices as shown in FIG. 3B.

In the subscriber wireless access system, when ARP data is broadcast-transmitted to inquire the MAC address of a communication terminal device such as a LAN in the same subscriber group, the ARP is controlled not to be input to another group as follows. For example, when the broadcast data is wirelessly transmitted from the subscriber station device 2-1 (subscriber station ID=1) of subscriber group 1, the base station apparatus 1 which receives the broadcast data decides the subscriber station ID belonging to the same group as that of the subscriber station ID of a transmission source with reference to the registration table 8-2 on the basis of the subscriber station MAC address of the transmission source included in the received wireless frame. The base station apparatus 1 routes broadcast data in which all the subscriber station IDs (in this example, subscriber station ID=1 and subscriber station ID=2) belonging to the same group obtained by the decision as shown in FIG. 3A are included in a wireless frame header as destinations in a wireless area.

Except for the subscriber station ID of the transmission source, other subscriber station IDs (in this embodiment, subscriber station ID=2) in the same group may be included in the wireless frame header.

The broadcast data wirelessly transmitted from the base station apparatus 1 is received by all the subscriber station devices in a wireless service area. However, when the destination subscriber station ID included in the header of the received wireless frame is not of each subscriber station device, the subscriber station device wastes the broadcast data. Only when the destination subscriber station ID is of the subscriber station device, the subscriber station device outputs the broadcast data to the output port (LAN port when a LAN is controlled by the base station apparatus 1) to forward the broadcast data to a communication terminal device controlled by the base station apparatus 1.

Therefore, since a receiving process of broadcast data is performed by only a subscriber station device belonging to the same group as that of a transmission source, unnecessary traffic to another subscriber station device which does not belong to the group can be prevented from being generated. In addition, since data can be broadcasted in only the same group, the secrecy of the data can be secured in the group.

As has been described above, according to the present invention, since forwarding of broadcast data is performed in only a subscriber station device group, an unnecessary increase in traffic can be prevented, and the secrecy of the broadcast data can be secured in the group.

According to the present invention, since group configuration management information of a subscriber station device can be updated, a group configuration can be flexibly changed depending on a request in execution. Furthermore, since the updating management process can be integrally performed by a network management device, the reliability of data communication in an entire network can be secured.

What is claimed is:

1. A subscriber wireless access system which has subscriber station devices wirelessly connected to base station apparatus, communication terminal devices being accommodated in the subscriber station devices, wherein
pieces of information for discriminating the subscriber station devices from each other are added to the subscriber station devices, pieces of group discrimination information representing the same group are added to a plurality of subscriber station devices wirelessly connected to the same base station apparatus to group the subscriber station devices, and
the base station apparatus holds corresponding information between pieces of individual discrimination information of the subscriber station devices and the pieces of group discrimination information, and, when the base station apparatus receives broadcast data from a subscriber station device, the base station apparatus designates a subscriber station device belonging to the same group as that of a subscriber station device of a transmission source as a destination to wirelessly transmit the broadcast data to the subscriber station device.

2. A subscriber wireless access system according to claim 1, wherein
the base station apparatus holds corresponding information between pieces of individual discrimination information of the subscriber station devices and the pieces of group discrimination information such that the corresponding information can be updated, and the group configuration of the subscriber station devices can be changed.

3. A subscriber wireless access system according to claim 2, comprising
a network management device connected to a base station apparatus through a communication network, and wherein the corresponding information between the pieces of individual discrimination information of the subscriber station devices held by the base station apparatus and the pieces of group discrimination information can be updated by the network management device.

4. A subscriber wireless access system according to claim 1, wherein
information according to a destination group of broadcast data is added to a subscriber station device as a tag set for a communication frame conforming to IEEE.

5. A subscriber wireless access system according to claim 2, wherein
information according to a destination group of broadcast data is added to a subscriber station device as a tag set for a communication frame conforming to IEEE.

6. A subscriber wireless access system according to claim 3, wherein
information according to a destination group of broadcast data is added to a subscriber station device as a tag set for a communication frame conforming to IEEE.

7. A subscriber wireless access system which has a base station apparatus connected to a communication network through a router and subscriber station devices wirelessly connected to the base station apparatus, communication terminal devices being accommodated in the subscriber station devices, wherein
the router is connected to the base station apparatus by a plurality of logical channels and holds corresponding information between IP addresses of data communicated on the communication network and the logical channels,
the base station apparatus holds corresponding information between the logical channels and pieces of information for discriminating the subscriber station devices from each other and corresponding information between pieces of group discrimination information of a plurality of subscriber station devices wirelessly connected to the base station apparatus and pieces of individual discrimination information of the subscriber station devices and sets destination information of data transmitted to a subscriber station device with reference to the pieces of corresponding information.

8. A subscriber wireless access method for grouping subscriber station devices and transmitting broadcast data to only a predetermined group, wherein
a base station apparatus designates a destination of the received broadcast data as a group with reference to group discrimination information representing that a plurality of subscriber station devices belong to the same group to wirelessly transmit the broadcast data to the subscriber station device, and
the subscriber station device which wirelessly receives the broadcast data outputs the broadcast data to a communication terminal device controlled under the subscriber station device only when the subscriber station device belongs to the group the destination of which is designated.

9. A subscriber wireless access method which changes a configuration of a group constituted by subscriber station devices wirelessly connected to the same base station apparatus, wherein
corresponding information between pieces of group discrimination information of the subscriber station devices held in the base station apparatus and pieces of individual discrimination information of the subscriber station devices is updated.
